(19) United States
(12) Patent Application Publication
(10) Pub. No.: US 2012/0133618 A1
(43) Pub. Date: May 31, 2012

(54) DISPLAY DEVICE WITH TOUCH SENSOR FUNCTIONALITY, AND LIGHT-COLLECTING/BLOCKING FILM

(76) Inventors: Naru Usukura, Osaka-shi (JP); Hiroaki Shigeta, Osaka-shi (JP); Ryuzo Yuki, Osaka-shi (JP)

(21) Appl. No.: 13/383,130

(22) PCT Filed: Jul. 7, 2010
(86) PCT No.: PCT/JP2010/061538

§ 371 Date: Jan. 9, 2012

(30) Foreign Application Priority Data
Jul. 10, 2009 (JP) 2009-164087

(51) Int. Cl. G06F 3/042

(52) U.S. Cl. 345/175

(57) ABSTRACT

A display device with touch sensor functionality with an enlarged distinction margin between the touch state and the non-touch state is provided. The display device with touch sensor functionality includes a light-collecting/blocking film (116) on the surface of the display device. The light-collecting/blocking film (116) includes an opening (212) that collects and passes light exiting the display device to the outside, and a light-blocking portion (213) that blocks a portion of light entering the display device.

### TECHNICAL FIELD

The present invention relates to a display device with touch sensor functionality, and a light-collecting/blocking film used in the same.

### BACKGROUND ART

Liquid crystal display devices with touch sensor functionality are known. For example, JP2008-241807A discloses a display device that uses an infrared sensor to detect infrared light that is not blocked by an instruction means, such as a finger, when the intensity of external light directed onto the display surface of the liquid crystal panel is higher than a predetermined value. When the intensity of external light is lower than the predetermined value, the display device uses a backlight to emit infrared light to be detected and uses the infrared sensor to detect the infrared light reflected by the instruction means.

### DISCLOSURE OF THE INVENTION

However, a liquid crystal display device with touch sensor functionality as described above does not exhibit a sufficient distinction margin between a touch state and a non-touch state. More specifically, the difference in levels of a detection signal generated when the instruction means is in contact with the display surface of the liquid crystal panel (i.e. during touch) and a detection signal generated when the instruction means is not in contact with the display surface (during non-touch) may not be sufficient. Accordingly, an object of the present invention is to provide a display device with touch sensor functionality with an enlarged distinction margin between the touch state and the non-touch state.

The display device with touch sensor functionality disclosed herein includes a light-collecting/blocking film provided on a surface of the display device. The light-collecting/blocking film includes: an opening that collects and passes light exiting the display device to an outside; and a light-blocking portion that blocks a portion of the light entering the display device.

In this arrangement, during touch, the light collected at the opening of the light-collecting/blocking film is reflected at the interface between an instruction means, such as a finger or pen, and the top of the opening, such that almost all the light returns into the display device with touch sensor functionality. During non-touch, even when the finger or the like is above the opening, the light exiting the opening of the light-collecting/blocking film and reflected by the finger is blocked, at least partially, by the blocking portion. Consequently, the difference between the level of a detection signal in the touch state and the level of a detection signal in the non-touch state is increased especially when the finger or the like is near the surface of the display device with touch sensor functionality in the non-touch state. Thus, a display device with touch sensor functionality capable of distinguishing between the touch state and the non-touch state is provided.

According to the present invention, a display device with touch sensor functionality and a light-collecting/blocking film capable of distinguishing between the touch state and the non-touch state are provided.

### BRIEF DESCRIPTION OF THE DRAWINGS

FIG. 1 is a schematic cross sectional view of a liquid crystal display device with touch sensor functionality according to Embodiment 1.

FIG. 2A is a schematic cross sectional view of a light-collecting/blocking film according to Embodiment 1.

FIG. 2B is another cross sectional view of the light-collecting/blocking film according to Embodiment 1.

FIG. 3A schematically illustrates paths of light in the non-touch state.

FIG. 3B schematically illustrates paths of light in the touch state.

FIG. 4A schematically illustrates, for comparison with the present embodiment, paths of light entering the liquid crystal display panel and light exiting it when no light-collecting/blocking film is provided.

FIG. 4B schematically illustrates paths of light entering the light-collecting/blocking film from the viewer's side and light entering it from the liquid crystal display panel.

FIG. 5A is a cross sectional view of an arrangement for protecting lenses.

FIG. 5B is a cross sectional view of another arrangement for protecting lenses.

FIG. 6A is a cross sectional view of an arrangement for fixing a light-collecting/blocking film.

FIG. 6B is a cross sectional view of another arrangement for fixing a light-collecting/blocking film.

FIG. 6C is a cross sectional view of still another arrangement for fixing a light-collecting/blocking film.

FIG. 7A is a cross sectional view of a variation of the light-collecting/blocking film according to Embodiment 1.

FIG. 7B is a cross sectional view of another variation of the light-collecting/blocking film according to Embodiment 1.

FIG. 8A is a perspective view of a light-collecting/blocking film illustrating an arrangement of openings and lenses.

FIG. 8B is a plan view of the light-collecting/blocking film illustrating the arrangement of openings and lenses.

FIG. 8C is a cross sectional view of the light-collecting/blocking film illustrating the arrangement of openings and lenses.

FIG. 9A is a perspective view of a light-collecting/blocking film illustrating another arrangement of openings and lenses.

FIG. 9B is a plan view of the light-collecting/blocking film illustrating the other arrangement of openings and lenses.

FIG. 9C is a cross sectional view of the light-collecting/blocking film illustrating the other arrangement of openings and lenses.

FIG. 10A is a cross sectional view of a light-collecting/blocking film according to Embodiment 2.

FIG. 10B is a plan view of the light-collecting/blocking film according to Embodiment 2.

FIG. 10C is another cross sectional view of the light-collecting/blocking film according to Embodiment 2.

FIG. 11 is a cross sectional view of another example of the light-collecting/blocking film according to Embodiment 2.

FIG. 12 is a plan view of still another example of the light-collecting/blocking film according to Embodiment 2.

### EMBODIMENTS FOR CARRYING OUT THE INVENTION

The display device with touch sensor functionality disclosed herein includes a light-collecting/blocking film provided on a surface of the display device. The light-collecting/blocking film includes: an opening that collects and passes light exiting the display device to an outside; and a light-blocking portion that blocks a portion of the light entering the display device.

It is preferable that the display device with touch sensor functionality described above further includes a lens corresponding to the opening.

The display device with touch sensor functionality described above may also be configured such that the opening and the light-blocking portion are arranged alternately in a single layer of the light-collecting/blocking film.

In the display device with touch sensor functionality described above, it is preferable that the opening is a translucent film, and the light-blocking portion is a light-blocking film.

The display device with touch sensor functionality described above may also be configured such that the light-collecting/blocking film includes a translucent film and light-blocking films arranged on one surface of the translucent film with a predetermined interval therebetween.

In the display device with touch sensor functionality described above, it is also preferable that the light-collecting/blocking film further includes a base material layer superposed on the layer including the opening and the light-blocking portion. The base material layer will serve to improve the flatness of the light-collecting/blocking film and protect its surface.

In the display device with touch sensor functionality described above, it is preferable that the light-blocking portion includes a reflecting surface reflecting light exiting the display device toward the opening. For example, it is preferable that the light-blocking portion is wedge-shaped light-blocking members arranged with a predetermined interval in the translucent film. It is also preferable that the light-collecting/blocking film further includes a base material layer superposed on the translucent film.

The display device with touch sensor functionality described above may also be configured such that the opening is circular when the light-collecting/blocking film is viewed from a viewer's side, and all the other portion than the opening is the light-blocking portion. Alternatively, the display device with touch sensor functionality described above may be configured such that the opening and the light-blocking portion are arranged in a striped manner when the light-collecting/blocking film is viewed from a viewer's side. Alternatively, the display device with touch sensor functionality described above may be configured such that the opening is rectangular when the light-collecting/blocking film is viewed from a viewer's side, and all the other portion than the opening is the light-blocking portion.

It is preferable that the display device with touch sensor functionality described above further includes a narrow-directivity backlight.

Further, the light-collecting/blocking film disclosed herein may be a light-collecting/blocking film provided on a surface of a display device with touch sensor functionality, including: an opening that collects and passes light exiting the display device to an outside; and a light-blocking portion that blocks a portion of the light entering the display device.

Specific embodiments of the present invention will be described below referring to the drawings. The drawings referred to in the description below schematically illustrate devices of the embodiments; the actual devices may include various additional arrangements that are not described herein. The drawings referred to in the description below do not represent the exact sizes of the elements or the exact size ratios of the elements.

### Embodiment 1

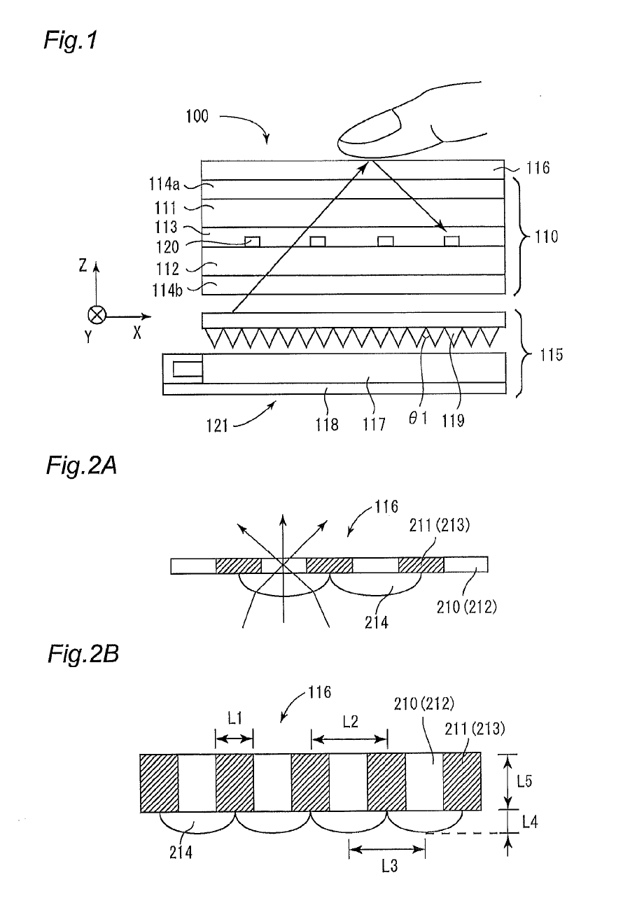

FIG. 1 is a cross sectional view of a liquid crystal display device 100 with touch sensor functionality according to Embodiment 1 of the present invention. As shown in FIG. 1, the liquid crystal display device with touch sensor functionality 100 according to the present embodiment includes, from the uppermost layer (viewer's side) downward, a light-collecting/blocking film 116, a liquid crystal display panel 110 and a backlight 115. A display device with touch sensor functionality described herein means a liquid crystal display device with capabilities of detecting a touch of an instruction means such as a finger. The touch sensor of the present embodiment is an optical sensor. The touch sensor may be incorporated in the active matrix substrate of the liquid crystal display device, as described in detail in the following embodiments. Alternatively, the display device with touch sensor functionality may include a touch sensor provided on a surface of the display device.

The liquid crystal display panel 110 includes, from the uppermost layer (viewer's side) downward, an optical film 114a, a CF (color filter) substrate 111, a liquid crystal layer 113, an active matrix substrate 112, and an optical film 114b. The CF substrate 111 and the active matrix substrate 112 are opposite each other. The liquid crystal layer 113 is formed between the active matrix substrate 112 and the CF substrate 111, with a spacer (not shown) interposed therebetween. The optical film 114a includes a viewing angle compensation plate, a retardation plate and a polarizer stacked upon each other on an adhesive layer. The optical film 114b includes a viewing angle compensation plate, a retardation plate, a polarizer and a brightness improvement film stacked upon each other on an adhesive layer.

The active matrix substrate 112 includes a plurality of pixels (not shown) arranged in a matrix. The region in which the pixels are arranged provides a display region in the liquid crystal display panel 110. The active matrix substrate 112 also includes photosensors 120 on the portion thereof that overlaps with the CF substrate 111 in the thickness direction of the liquid crystal display panel 110. The photosensors 120 may be photodiodes, for example.

In the present embodiment, the number of photosensors 120 is substantially the same as that of pixels. The photosensors 120 are formed utilizing the step of forming various components of the active matrix substrate 112 (i.e. TFTs (thin film transistors) or various lines for driving the pixels), at the same time with these components. That is, the active matrix substrate 112 containing the photosensors 120 is monolithic. Further, the CF substrate 111 includes a transmissive portion that passes light to be detected in the regions that overlap with the optical sensors 120 in the thickness direction of the liquid crystal display panel 110, such that light to be detected is not prevented from entering the photosensors 120.

In the active matrix substrate 112, a source driver (not shown) and a gate driver (not shown) are provided in a periphery region (not shown) that does not overlap with the CF substrate 111. In the present embodiment, the source driver and the gate driver are formed concurrently with various components of the pixels, similarly to the photosensors 120.

It is desirable that the backlight 115 is a narrow-directivity backlight to improve light use efficiency and facilitate distinction between touch and non-touch. The narrow-directivity backlights may be an edge-light, reversed prism TL backlight, for example. When the light emitting surface of the backlight is an X-Y plane, a TL backlight can mainly have a narrow directivity with respect to just one direction (the X direction, for example). The backlight 115 shown in FIG. 1 is one example of a TL backlight, and includes a light guide plate 117, a reflecting plate 118, a reversed prism film 119 and an LED 121. It should be noted that, while the backlight 115 is an edge-light backlight in the present embodiment, it may be a direct-lighting backlight.

The light guide plate 117 has a pattern (not shown) such as a prism or lens on the top and bottom surfaces. The reflecting plate 118 may be a silver sheet. It should be noted that the reflecting plate 118 may be an ESR (enhanced specular reflector) or a white PET. A white PET means a PET (polyethylene terephthalate) mixed with inorganic materials such as titanium oxide or calcium carbonate. In the present embodiment, the reversed prism film 119 has a prism apex angle θ of 68 degrees. To achieve a narrow-directivity backlight, it is preferable that the reversed prism film 119 has an apex angle θ of 40 to 75 degrees. This will achieve a narrower directivity of light in a direction of a cross section of the reversed prisms in which the apexes and notches appear (the X direction of FIG. 1).

It is preferable that the half-value angle of the light source is around plus or minus 5 to 15 degrees, for example. In the present embodiment, the light source is an LED 121, however, it may also be a cold-cathode tube. Further, to achieve a narrow directivity of the backlight 115, it is preferable that the light source is disposed such that light enters one side of the light guide plate 117. However, the light source may also be disposed such that light enters two sides of the light guide plate 117.

Typically, a light source that emits light in the visible light range (380 to 800 nanometers) is used; however, a light source that emits light in the infrared range (800 nanometers and above) may also be used in the context of photosensors. The present embodiment will be described for an implementation including an LED emitting light in the visible light range and an LED emitting light in the infrared range.

FIG. 2A is a schematic cross sectional view of a light-collecting/blocking film 116 according to the present embodiment. In FIG. 2A, only the portions made of a light-blocking material are hatched. Hatching is made similarly in other drawings.

As shown in FIG. 2A, the light-collecting/blocking film 116 includes translucent resin films 210, light-blocking films 211 and lenses 214. The resin films 210 and the light-blocking films 211 are provided alternately in a single plane. In this implementation, each of the resin films 210 is an opening 212 and each of the light-blocking films 211 is a light-blocking portion 213. Each of the openings 212 passes light. Each of the lenses 214 collects light exiting the touch panel into its corresponding opening 212.

Now, a process of manufacturing a light-collecting/blocking film 116 as shown in FIG. 2A will be described. First, a glass plate is patterned with a light-blocking material to form light-blocking portions 213. Next, an acrylic photosensitive resin is applied to the glass having the light-blocking portions 213. The light-blocking portions 213 are used as a mask to expose the photosensitive resin to be etched to leave photosensitive resin on and around the openings. Thereafter, the remaining photosensitive resin is heated and thus deformed to form lenses 214. These steps provide a light-collecting/blocking film 116 as shown in FIG. 2A. To achieve a larger difference in signal levels between the touch state and the non-touch state, it is desirable that the light-collecting/blocking film 116 is disposed such that the surface of the film that has no lens 214 faces the viewer.

Referring to FIG. 2B, the preferred sizing of the light-collecting/blocking film 116 will be described. Preferably, the ratio of the width L1 of a light-blocking portion 213 relative to the pitch (light-blocking portion pitch) L2 between two adjacent light-blocking portions 213 is 2:5. Preferably, the light-blocking portion pitch L2 is substantially the same as the pitch L3 between two adjacent lenses. When the refractive index of the resin films 210 is 1.6 and the radius of curvature R of the lenses is 50 micrometers, it is preferable that the width L1 of a light-blocking portion is 20 micrometers, the light-blocking portion pitch L2 is 50 micrometers, the lens pitch L3 is 50 micrometers, the lens thickness L4 is 6.5 micrometers, the film thickness L5 is 120 micrometers, as in the light-collecting/blocking film 116 shown in FIG. 2B as one example. This sizing will improve the difference in signal levels between the touch state and the non-touch state to 1.5 times that of the conventional implementation.

Preferably, each of the lenses 214 is shaped to allow light to be focused on an opening 212 between two light-blocking films 212. For example, when the lenses 214 have a refractive index of 1.6 and a radius of curvature R of 50 micrometers, it is preferable that the focal distance is around 120 micrometers. It should be noted that, in the light-collecting/blocking film 116, a transparent layer may be provided between the lenses 214 and the light-blocking films 211 to optimize the focal distance.

Most preferably, the lens pitch L3 is 10 to 50 micrometers for interference and manufacturing reasons, and may preferably be 20 to 50 micrometers. This is because a larger lens pitch L3 tends to cause moiré due to interference between the pattern of the light-blocking portions 213 and the pixel pattern of the liquid crystal display device, and because a lens pitch L3 that is too small makes it difficult to keep the accuracy of the shape of the lenses 214.

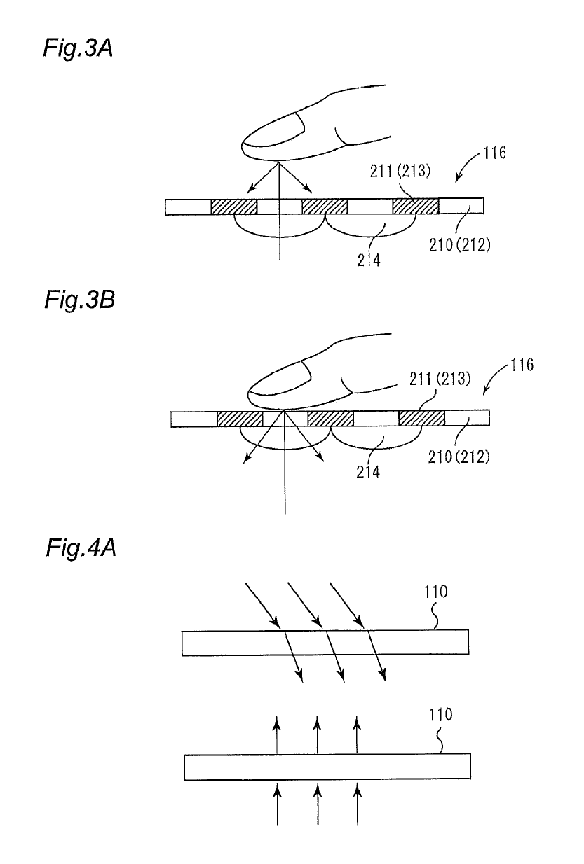

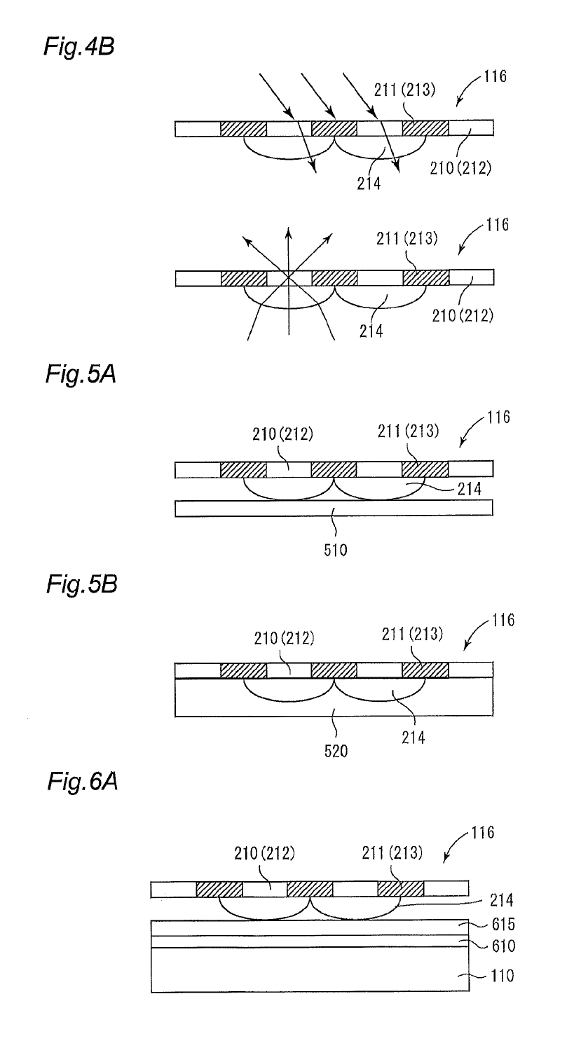

Next, effects of the light-collecting/blocking film 116 in the present embodiment will be described referring to FIGS. 3A, 3B, 4A and 4B. FIG. 3A illustrates paths of light directed when the finger is not in contact with the liquid crystal display panel with touch sensor functionality 100 (i.e. the non-touch state). In the non-touch state, light exiting the liquid crystal display panel 110 is reflected above the opening 212. A portion of the reflected light is blocked by a light-blocking portion 213 and the remaining portion of the light enters the display surface. On the other hand, FIG. 3B illustrates paths of light directed when the finger is in contact with the liquid crystal display panel with touch sensor functionality 100 (i.e. the touch state). In the touch state, the light collected from the liquid crystal display panel 110 into an opening 212 is reflected at the surface of the opening 212 such that almost all of it returns into the liquid crystal display panel 110. Thus, the difference between the touch state and the non-touch state is emphasized.

FIG. 4A schematically illustrates, for comparison with the present embodiment, light entering the liquid crystal panel 110 and light exiting it when no light-collecting/blocking film 116 is provided. FIG. 4B schematically illustrates light entering the light-collecting/blocking film 116 from the viewer's side and light entering it from the liquid crystal display panel 110.

As shown in FIG. 4A, when no light-collecting/blocking film 116 is provided, all the light from the outside enters the liquid crystal display panel 110 without being blocked. As shown in FIG. 4B, when a light-collecting/blocking film 116 is provided, part of the light from the outside is blocked and thus noise light from outside the liquid crystal display panel 110 is blocked. On the other hand, light exiting the inside of the liquid crystal display panel 110 is collected into an opening 212 by a lens 214, as shown in 4B, such that almost all the light exits the light-collecting/blocking film 116 toward the viewer's side without being blocked.

FIGS. 5A and 5B are schematic cross sectional views of arrangements for protecting lenses 214 from depression on the light-collecting/blocking film 116 from the outside. In the implementation shown in FIG. 5A, a protective layer 510 is provided under the lenses. It is most preferable for reasons of refractive index and adhesiveness that the protective layer 510 is made of the same material as the lenses 214, for example. The protective layer 510 may also be made of an acrylic resin or the like. Alternatively, as shown in FIG. 5B, a low-refractive index resin 520 having a lower refractive index than the lenses 214 may be deposited on the surface of the light-collecting/blocking film 116 having the lenses 214. The low-refractive index resin 520 may be made of an acrylic resin, for example. Preferably, the refractive index of the low-refractive index resin 520 is as low as possible to produce a refractive difference between the resin and the lenses 214. Preferably, the refractive index of the low-refractive index resin 520 is around 1.3, for example. The entire lenses 214 are embedded in the low-refractive index resin 520 to protect the lenses 214. Thus, a protective layer 510 or a low-refractive index resin 520 will prevent deformation of the lenses 214 when they are depressed from the outside.

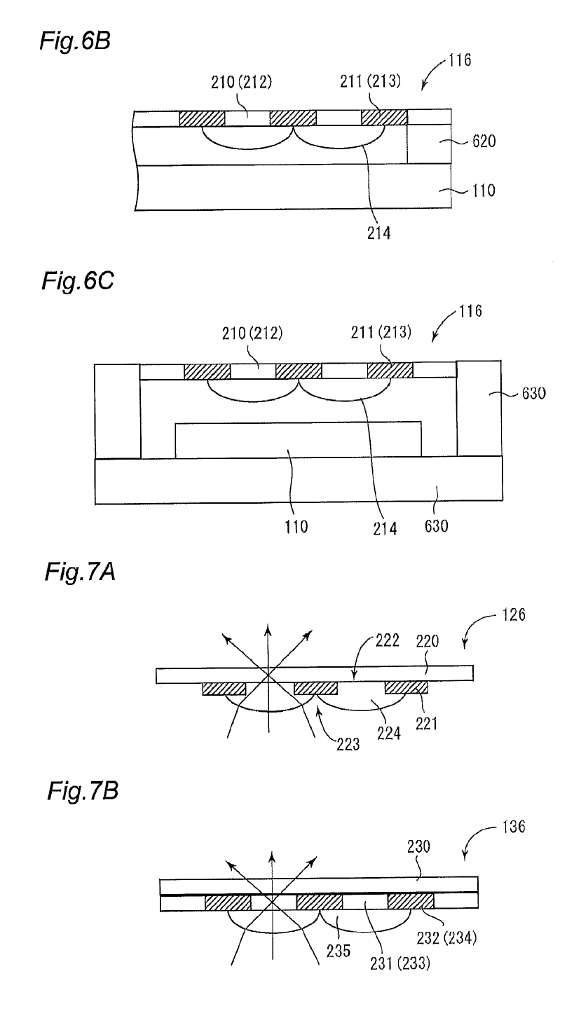

FIGS. 6A, 6B and 6C are cross sectional views of arrangements for fixing the light-collecting/blocking film 116 onto the liquid crystal display panel 110. In the implementation shown in FIG. 6A, an adhesive layer 610 is provided on the liquid crystal display panel 110, and a light-collecting/blocking film 116 is provided above the adhesive layer 610. A protective layer 615 is provided between the adhesive layer 610 and the lenses 214 on the light-collecting/blocking film 116. The protective layer 615 is provided to prevent adhesive material of the adhesive layer 610 from entering gaps between lenses 214.

In the implementation shown in FIG. 6B, a peripheral spacer 620 is provided in the form of a casing on the liquid crystal display panel 110, and a light-collecting/blocking film 116 is provided on the peripheral spacer 620. In the implementation shown in FIG. 6C, the liquid crystal display panel 110 is disposed inside a finished frame 630, and the light-collecting/blocking film 116 is provided to close the opening of the frame 630.

Now, variations of the light-collecting/blocking film 116 will be described. FIGS. 7A and 7B show variations of the light-collecting/blocking film 116.

The light-collecting/blocking film 126 shown in FIG. 7A includes a translucent resin film 220, light-blocking films 221 and lenses 224. The light-blocking films 221 are disposed on one side of the resin film 220 with a predetermined interval. The interval between two adjacent light-blocking films 221 is an opening 222, and each of the light-blocking films 221 is a light-blocking portion 223. A lens 224 is provided to cover an opening 222 on the side of the resin film 220 having the light-blocking films 221. A lens 224 is provided to collect light from the liquid crystal display panel 110 into its corresponding opening 222.

The light-collecting/blocking film 126 shown in FIG. 7A may be formed by stacking an acrylic resin film 220, for example, and light-blocking films 221, slicing them, and performing exposure and heating, as described above. The light-collecting/blocking film 126 has an excellent flatness on the topmost surface and an excellent durability, including abrasion-resistance, since its topmost surface is the resin film 220.

In the light-collecting/blocking film 136 shown in FIG. 7B, a second layer having alternate resin films 231 and light-blocking films 232 in a single plane is provided on the backside of the resin film 230 (base material layer). The interval between two adjacent light-blocking films 232 is an opening 233, and each of the light-blocking films 232 is a light-blocking portion 234. On the backside of the second layer including the resin films 231 and the light-blocking films 232, lenses 235 are provided to collect light from the liquid crystal display panel 110 into their respective openings 233. While the implementation of FIG. 7B uses a resin film 230 as a base material layer, the resin film 230 may be replaced by a resin or glass substrate with a sufficient hardness. This will further improve the flatness and durability of the light-collecting/blocking film 136.

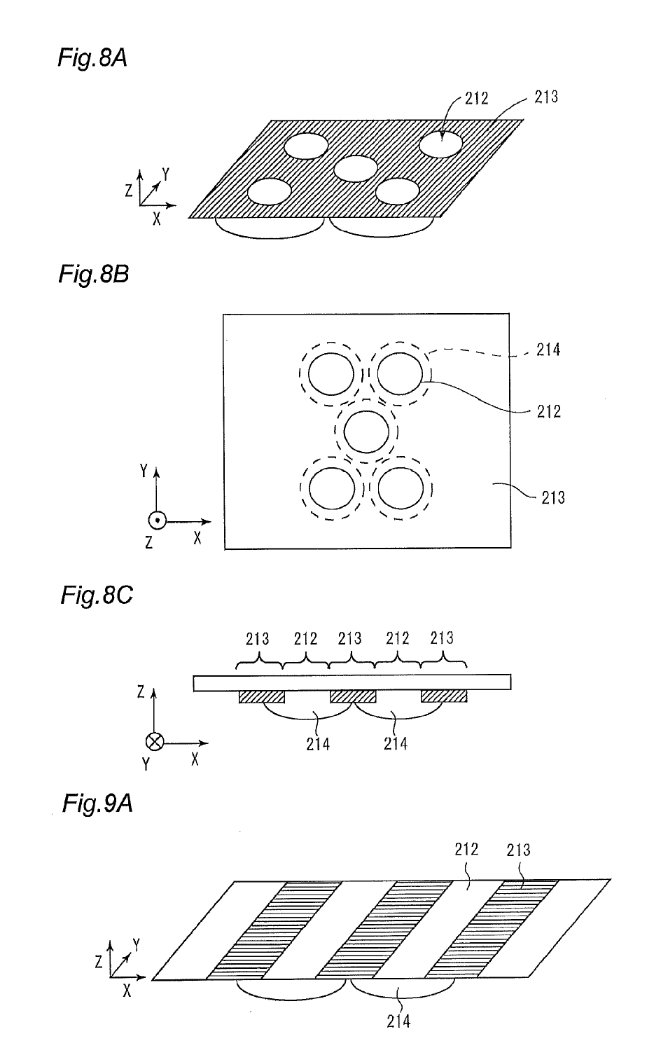

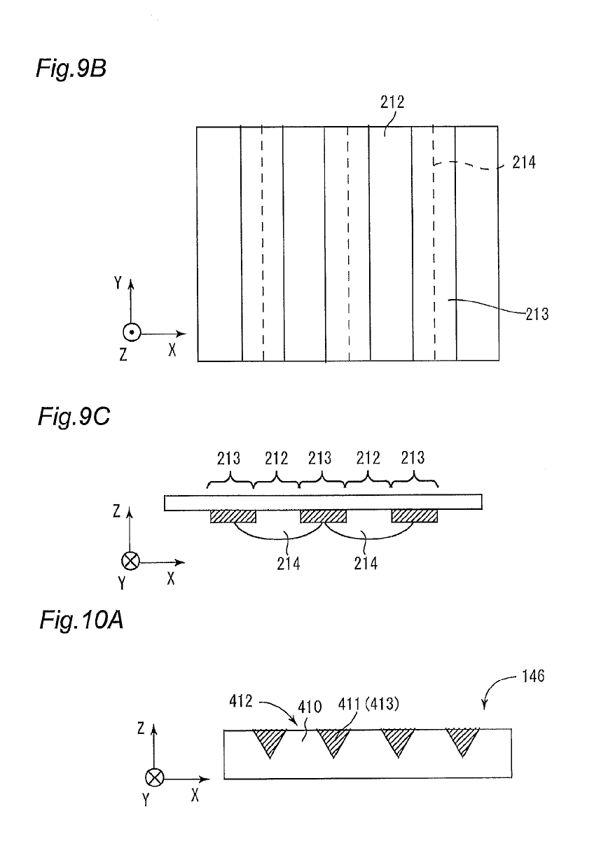

FIGS. 8A to 8C and FIGS. 9A to 9C illustrate the positional relationships between the openings and lenses. FIGS. 8A and 9A are perspective views; FIGS. 8B and 9B are plan views; and FIGS. 8C and 9C are cross sectional views.

In the implementations shown in FIGS. 8A to 8C, the openings 212 are circular, and generally spherical lenses 214 are provided to cover their respective openings 212 from the backside. If the lenses 214 are generally spherical, it is desirable that the backlight 115 has a narrow directivity with respect to both the X and Y directions.

Alternatively, as shown in FIG. 9A, the lenses 214 may be semi-circular in the X-Z cross section and rectangular in the X-Y cross section and collect light in the X direction (lenticular lenses). If the backlight 115 is a TL backlight, it has a narrow directivity with respect to one of the X and Y directions. Thus, it is desirable that the lenses 214 are such lenticular lenses.

### Embodiment 2

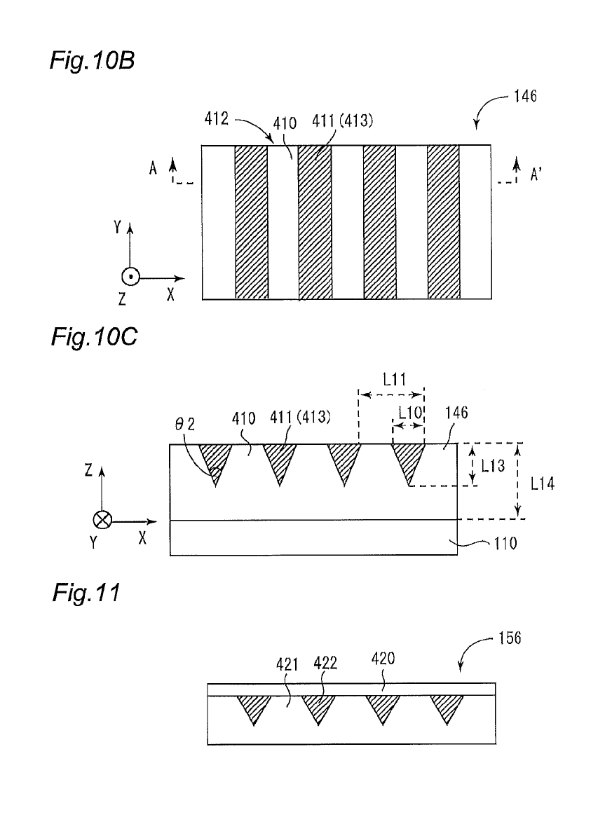

Now, another embodiment of the present invention will be described. FIGS. 10A, 10B and 10C schematically illustrate a light-collecting/blocking film 146 in Embodiment 2. FIGS. 10A and 10C are cross sectional views, and FIG. 10 B is a plan view. The light-collecting/blocking film 146 according to the present embodiment replaces the light-collecting/blocking film 116 of Embodiment 1 and is disposed on the viewer's side of the liquid crystal display panel 110.

As shown in FIG. 10A, the light-collecting/blocking film 146 includes a resin film 410 and light-blocking members 411 disposed on one surface of the resin film 410 with a predetermined interval. Each light-blocking member 411 is wedge-shaped in the X-Z cross section, as shown in FIG. 10A, and is rectangular in the X-Y cross section, as shown in FIG. 10B. That is, the width of each light-blocking member 411 becomes smaller as it goes from the surface of the light-collecting/blocking film 146 toward its inside. Within the light-collecting/blocking film 146, the interface between a light-blocking member 411 and a resin film 410 is inclined with respect to the surface of the light-collecting/blocking film 146. The interval between two adjacent light-blocking members 411 is an opening 412, and each of the light-blocking members 411 is a light-blocking portion 413. A light-blocking member 411 may be made of a negative photosensitive resist including a pigment or carbon dispersed in a base resin such as an acrylic resin or a polyimide resin.

Preferably, the refractive index of the light-blocking members 411 is lower than that of the resin film 410. Thus, light from the liquid crystal display panel 110 enters the resin film 410 and is then totally reflected on the interface between the resin film 410 and a light-blocking member 411 and collected into an opening 412. As shown in FIG. 10B, in the light-collecting/blocking film 146, the light-blocking members 411 are disposed in a striped manner as viewed from above (from the viewer's side). That is, the light-blocking members 411 are disposed parallel to each other in the X-Y cross section of the light-collecting/blocking film 146. FIG. 10A is a cross sectional view taken along line A-A′ of FIG. 10B.

FIG. 100 shows the preferable sizing of the light-collecting/blocking film 146. Preferably, the ratio of the width L10 of a light-blocking portion 413 to the pitch L11 is 1:2. Preferably, the apex angle θ2 of a light-blocking member 411 is around 16 degrees. For example, when the refractive index of the resin film 410 is 1.6, the refractive index of the light-blocking members 411 is 1.3, the pitch L11 between two adjacent light-blocking portions 413 is 50 micrometers, the width L10 of a light-blocking portion 413 is 25 micrometers, the apex angle of the light-blocking members 411 is 16 degrees, the height L13 of the light-blocking members 411 is 90 micrometers, the thickness L14 of the resin film 410 is 120 micrometers and the half-value angle of the backlight is plus or minus 10 degrees, then the difference between the touch state and the non-touch state is improved to 1.3 times that of the conventional implementation.

FIG. 11 is a cross sectional view of another example of the light-collecting/blocking film according to the present embodiment. The light-collecting/blocking film 156 shown in FIG. 11 includes a resin film 420 (base material layer) on its top. A resin film 421 is provided below the resin film 420. Light-blocking members 422 are provided on the surface of the resin film 421 having the resin film 420 thereon with a predetermined interval. A light-blocking member 422 is wedge-shaped in the X-Z cross section and rectangular in the X-Y cross section. The interval between two adjacent light-blocking members 422 is an opening, and each of the light-blocking members 422 is a light-blocking portion. The resin film 420 may be replaced by a glass substrate as the base material layer.

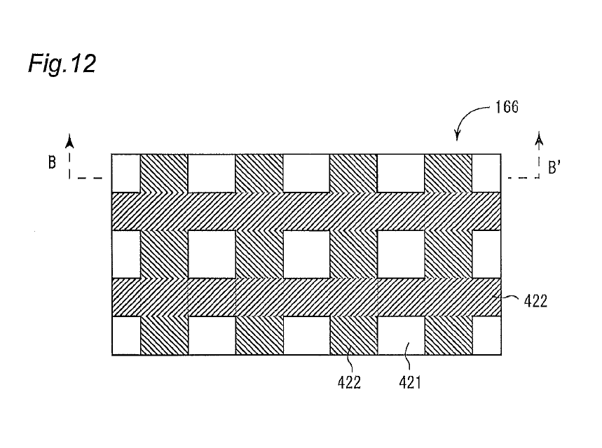

FIG. 12 is a plan view of still another example of the light-collecting/blocking film according to the present embodiment. As shown in FIG. 12, a light-collecting/blocking film 166 including a light-blocking member 422 shaped as a grid as viewed from the viewer's side is an embodiment. The cross section taken along B-B′ of FIG. 12 may be as shown in FIG. 11 or may be similar to the arrangement shown in FIG. 10A.

While the above embodiments have illustrated arrangements where photosensors are incorporated in the liquid crystal panel, the present invention is not limited thereto and may be employed in various display devices, such as organic EL (electroluminescence) devices or PDPs (plasma display panels). That is, using a light-collecting/blocking film as described above in any display device incorporating photosensors will achieve the effects similar to those from the above embodiments. Further, the above embodiments have illustrated arrangements where photosensors 120 are incorporated in the liquid crystal display panel 110, the present invention is not limited thereto, and an arrangement with a film or sheet including photosensors deposited on the display device will achieve the similar effects.

When light in the infrared range (at, for example, 900 nanometers) is used for sensing, the light-collecting/blocking film described above will provide the expected effects if light in the infrared range is collected and blocked. Accordingly, particularly the light-blocking portions may be made of a material that passes visible light but blocks light in the infrared range. That is, if infrared light is used for sensing, the light-blocking portions of the light-collecting/blocking film may be made of a material that looks transparent to the human eye. Further, it is desirable that the lenses that serve to collect light in the light-collecting/blocking film are optimized for lens shape or refractive index suitably for light in the infrared range used for sensing.

As described above, according to the embodiments, in the touch state, almost all the light reflected by the interface between an instruction means such as a finger and the surface of the top of an opening returns into the liquid crystal display panel 110. In the non-touch state, a portion of light that has exited an opening and has been reflected by an instruction means above the opening is blocked by a light-blocking portion. Thus, the difference between the amount of detected light in the touch state and the amount of detected light in the non-touch state is larger. Accordingly, a display device with touch sensor functionality and a light-collecting/blocking film capable of distinguishing between the touch state and the non-touch state is provided.

The arrangements described in the above embodiments merely illustrates examples and are not intended to limit the technical scope of the present invention. Any arrangement that achieves the effects of the present invention can be employed.

1. A display device with touch sensor functionality, comprising:
a light-collecting/blocking film provided on a surface of the display device, the light-collecting/blocking film including:
an opening that collects and passes light exiting the display device to an outside; and
a light-blocking portion that blocks a portion of the light entering the display device.

2. The display device with touch sensor functionality according to claim 1, further including a lens corresponding to the opening.

3. The display device with touch sensor functionality according to claim 1, wherein:
the opening and the light-blocking portion are arranged alternately in a single layer of the light-collecting/blocking film.

4. The display device with touch sensor functionality according to claim 3, wherein:
the opening is a translucent film; and
the light-blocking portion is a light-blocking film.

5. The display device with touch sensor functionality according to claim 3, wherein:
the light-collecting/blocking film includes:
a translucent film and;
light-blocking films arranged on one surface of the translucent film with a predetermined interval therebetween.

6. The display device with touch sensor functionality according to claim 3, wherein:
the light-collecting/blocking film further includes a base material layer superposed on the layer including the opening and the light-blocking portion.

7. The display device with touch sensor functionality according to claim 1, wherein the light-blocking portion includes a reflecting surface reflecting light exiting the display device toward the opening.

8. The display device with touch sensor functionality according to claim 7, wherein the light-blocking portion is wedge-shaped light-blocking members arranged with a predetermined interval in the translucent film.

9. The display device with touch sensor functionality according to claim 8, wherein the light-collecting/blocking film further includes a base material layer superposed on the translucent film.

10. The display device with touch sensor functionality according to claim 1, wherein the opening is circular when the light-collecting/blocking film is viewed from a viewer's side, and all the other portion than the opening is the light-blocking portion.

11. The display device with touch sensor functionality according to claim 1, wherein the opening and the light-blocking portion are arranged in a striped manner when the light-collecting/blocking film is viewed from a viewer's side.

12. The display device with touch sensor functionality according to claim 1, wherein the opening is rectangular when the light-collecting/blocking film is viewed from a viewer's side, and all the other portion than the opening is the light-blocking portion.

13. The display device with touch sensor functionality according to claim 1, further comprising a narrow-directivity backlight.

14. A light-collecting/blocking film to be provided on a surface of a display device with touch sensor functionality, comprising:
an opening that collects and passes light exiting the display device to an outside; and
a light-blocking portion that blocks a portion of the light entering the display device.
